(19) United States
(12) Patent Application Publication
(10) Pub. No.: US 2012/0233315 A1
(43) Pub. Date: Sep. 13, 2012

(54) SYSTEMS AND METHODS FOR SIZING RESOURCES IN A CLOUD-BASED ENVIRONMENT

(76) Inventors: Jason A. Hoffman, San Francisco, CA (US); James Duncan, Sainte-Anne-des-Lacs (CA); Mark G. Mayo, Port Moody (CA); David P. Young, San Anselmo, CA (US)

(21) Appl. No.: 13/046,660

(22) Filed: Mar. 11, 2011

(51) Int. Cl. G06F 15/173

(52) U.S. Cl. 709/224

(57) ABSTRACT

Systems and methods for sizing resources in a cloud-based environment are provided. In an exemplary embodiment, a method includes receiving quality of service requirements and a functional description of a cloud architecture associated with the application, including application resources and relations between the application resources, performing latency analysis of data packets in a compute layer of the cloud architecture, with the latency analysis including comparing size per time metrics of the data packets, determining minimal resources to guarantee the quality of service requirements based on the latency analysis and the quality of service requirements, and providing to the data center the minimal resources.

### CROSS-REFERENCE TO RELATED APPLICATIONS

This nonprovisional patent application is related to U.S. patent application Ser. No. 12/696,334, filed on Jan. 29, 2010, entitled “MANAGING WORKLOADS AND HARDWARE RESOURCES IN A CLOUD RESOURCE,” to U.S. patent application Ser. No. 12/696,619, filed on Jan. 29, 2010, entitled “PROVISIONING SERVER RESOURCES IN A CLOUD RESOURCE,” to U.S. patent application Ser. No. 12/696,802, filed on Jan. 29, 2010, entitled “MANAGING HARDWARE RESOURCES BY SENDING MESSAGES AMONGST SERVERS IN A DATA CENTER,” to U.S. Provisional Patent Application No. 61/295,375, filed on Jan. 15, 2010, entitled “MANAGING WORKLOADS AND HARDWARE RESOURCES IN A CLOUD RESOURCE,” and PCT Patent Application No. PCT/US2011/021157 filed on Jan. 13, 2011, entitled “MANAGING WORKLOADS AND HARDWARE RESOURCES IN A CLOUD RESOURCE”—all of which are hereby incorporated by reference herein in their entirety including all references cited therein.

### FIELD OF THE INVENTION

Embodiments disclosed herein relate generally to data processing. More particularly, these embodiments relate to systems and methods for sizing resources in a cloud-based environment.

### BACKGROUND

Cloud computing enables convenient, on-demand network access to a shared pool of configurable computing resources that can be provisioned and released with minimal management effort or service provider interaction. There are presently a number of companies providing cloud computing services. Typically, these companies provide a computing platform, which facilitates deployment of applications without the cost and complexity of buying and managing the underlying hardware and software layers. Thus, instead of purchasing servers, software, data-center space or network equipment, clients may instead buy those resources as a fully outsourced service. However, estimating the amount of resources needed to support a cloud application is difficult because there is no common set of metrics to describe performance of the overall architecture within the compute layer. Thus, presently there is no reliable way of estimating the sizes of resources needed based on a desired quality of service.

### SUMMARY OF THE INVENTION

This summary is provided to introduce a selection of concepts in a simplified form that are further described below in the Detailed Description of Exemplary Embodiments. This summary is not intended to identify key features or essential features of the claimed subject matter, nor is it intended to be used as an aid in determining the scope of the claimed subject matter.

In an exemplary embodiment, a method for provisioning application resources in a cloud-based environment may include receiving quality of service requirements and a functional description of a cloud architecture associated with a cloud application, with the cloud architecture including application resources and relations between the application resources; performing latency analysis of data packets in a compute layer of the cloud architecture, with the latency analysis including comparing size per time metrics of the data packets; determining a minimal cloud architecture for the cloud application based on the latency analysis and the desired quality of service requirements, with the minimal cloud architecture including the application resources to guarantee the desired quality, of service requirements; and providing to a data center the minimal cloud architecture.

The cloud application may be running on a tablet-type client device. The functional description may include tiers of the cloud architecture, wherein the tiers may include a load balancer, a firewall, a web server, an application server, a database, a runtime environment and the like. In some embodiments, exemplary methods may further include guaranteeing quality of service and content delivery within a content delivery network. The quality of service requirements may include specific requirements of overall availability, performance, and minimal uplink guarantees. The latency analysis may be performed within a virtual environment and be based on kernel statistics, wherein the kernel statistics include a number of active processes, a total virtual memory size, and a number of hard disks used.

In further exemplary embodiments; a method for provisioning resources in a cloud environment may include receiving quality of service requirements, determining a cloud architecture to guarantee the desired quality of service, performing latency analysis on data packets in the compute layer, determining sizes of resources included in the cloud architecture based on the latency analysis, and describing the resources and their sizes to the data center.

In further example embodiments, modules, subsystems, or devices can be adapted to perform the recited steps. Other features and example embodiments are described below.

### BRIEF DESCRIPTION OF THE DRAWINGS

The embodiments are illustrated by way of example and not limitation in the figures of the accompanying drawings in which like references indicate similar elements.

FIG. 1 is a block diagram showing a network environment within which the systems and methods for sizing resources in a cloud-based environment are implemented, according to various embodiments.

FIG. 2 shows an exemplary cloud environment within which systems and methods described herein are implemented.

FIG. 3 shows a workflow of an exemplary method for sizing application resources in a cloud-based environment.

FIG. 4 shows an exemplary server in the data center of FIG. 1, according to various embodiments.

FIG. 5 shows a block diagram of an exemplary data processing system.

FIG. 6 shows a block diagram of an exemplary user device, according to various embodiments.

FIG. 7 shows an exemplar messaging system architecture for the data center of FIG. 1.

FIG. 8 shows an exemplary process for initiating a new agent on a server in the data center of FIG. 1.

FIG. 9 shows base services for the cloud control system of the data center of FIG. 1, according to exemplary embodiments.

### DETAILED DESCRIPTION OF EXEMPLARY EMBODIMENTS

Systems and methods for sizing resources in a cloud-based environment are described herein. As mentioned earlier herein, presently there is no reliable way of estimating the sizes of resources needed based on a desired quality of service. Accordingly, clients need to account for the worst case scenario when selecting the amount of resources needed to support a cloud application. Because customers are billed based on the amount of the resources selected, this approach results in customers paying for an amount of resources they rarely use. Even then, there is no guarantee of reliable and deterministic performance because the performance within the compute layer cannot be reliably predicted. Additionally, when performance failures do occur, there is no reliable way determine which part of the overall architecture is responsible.

The following description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment, and such references mean at least one. Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described, which may be requirements for some embodiments but not other embodiments.

Systems and methods provided herein address those issues. In particular, exemplary embodiments include a method for sizing resources which may allow deployment of optimal cloud architecture within a cloud data center, based on the quality of service requirements and a functional description of the cloud architecture. The cloud architecture, as used herein, may refer to a distributed system architecture of the software systems involved in the delivery of cloud computing, typically involves multiple cloud components communicating with each other over application programming interfaces, web services and multi-tier architecture. The cloud architecture may include a front end and a back end, which are not necessarily arranged as a traditional client-server architecture with a monolithic server. Instead, the cloud architecture may include a client's network (or computer) and the applications used to access the cloud via a user interface such as a web browser. The back end of the cloud architecture may include a distributed data center comprising various computers, servers and data storage devices. Because the cloud architecture is a distributed system architecture, communications between multiple cloud components are generally asynchronous and is triggered by predetermined events.

The functional description may include application resources and relations between the application resources. To determine the optimal cloud architecture, a latency analysis of data packets may be performed, with the latency analysis being based on a comparison of size per time metrics of the data packets traveling within the compute layer of the architecture. The optimal cloud architecture may include application resources of minimal sizes to guarantee the desired quality of service. The optimal cloud architecture may be described via an API and communicated to a data center. It will be noted that, as used herein, the API refers to a declarative language, which may enable autonomy and discoverability. The declarative language is programming language that may express the logic of a computation without describing its control flow. Instead of providing an explicit algorithm, he declarative language may attempt to minimize or eliminate undesired consequences by describing what the program should accomplish, rather than describing how to accomplish it. The autonomy mentioned above may refer to the self-managing characteristics of distributed computing resources, adapting to unpredictable changes whilst hiding intrinsic complexity to operators and users. Such characteristics may facilitate developing computer systems capable of self-management, to overcome the rapidly growing complexity of computing systems management, and to reduce the barrier that complexity poses to further growth. An autonomic system may make decisions on its own, using high-level policies and constantly check and optimize its status and automatically adapt itself to changing conditions.

The discoverability may be ensured by a zero configuration networking (zeroconf), which is a set of techniques that automatically creates a usable Internet Protocol (IP) network without manual operator intervention or special configuration servers. Zero configuration networking may allow inexpert users to connect computers, networked printers, and other network devices and expect a functioning network to be established automatically. Without zeroconf, a user may need to either set up special services, like Dynamic Host Configuration Protocol (DHCP) and Domain Name System services (DNS), or set up each computer's network settings manually, which may be difficult for non-technical or novice users.

The following provides an example of the API (declarative language) discussed above.

{

vlan: [‘myproject’],
machines: [

{

type: ‘smartos’
tags: [‘appserver’, ‘myproject’]

},
{

type: ‘smartos’,
tags: [‘appserver’, ‘myproject’]

},
{

type: ‘mysql’,
tags: [‘dbserver’, ‘master’, ‘myproject’]

},
{

type: ‘mysql’,
tags: [‘dbserver’, ‘slave’, ‘myproject’]

}

],
balance: [

{

protocol: ‘http’,
port: 80,
machines: [‘appserver’,‘myproject’]

},
{

protocol: ‘mysql’,
port: 3306
machines: [‘dbserver’,‘master‘,‘myproject’]
additional: [‘INSERT’,‘UPDATE’,‘DELETE’]

},
{

protocol: ‘mysql’,
port: 3306,
machines: [‘dbserver’,‘slave‘,‘myproject’],
additional: [‘SELECT’, ‘*’]

],
replicate: {

from: [‘dbserver’,‘master’],
to: [‘dbserver’,‘slave’]

}

}

Based on the API, the data center may provision the resources of appropriate sizes.

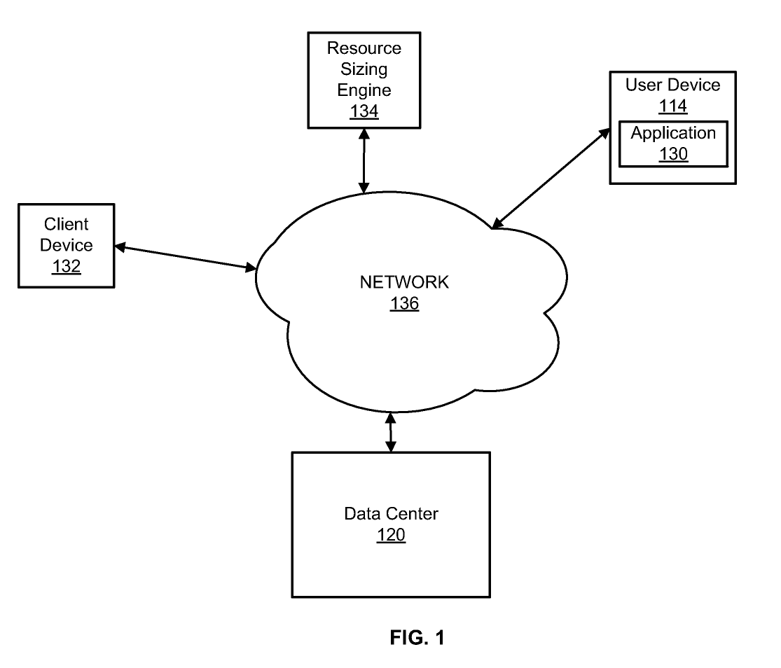

Turning to FIG. 1, FIG. 1 is a block diagram showing a network environment within which the systems and methods for sizing resources in a cloud-based environment are implemented, according to an embodiment. The network environment may include a network 136. The network 136 may include various data processing nodes interconnected for the purpose of data communication, which may be utilized to communicatively couple various components of the network environment 136. The network 136 may include the Internet or any other network capable of communicating data between devices.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 136 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

The network environment as shown in FIG. 1 may further include a user device 114. The user device 114 includes a computing device, having a display screen with touch input and/or a miniature keyboard. Heading into the future, Internet and multimedia-enabled smartphones are becoming ubiquitous end-user devices. These tablet-type devices come in multiple sizes but commonly include a complete personal mobile computer equipped with a touch screen and primarily operated by touching the screen. These devices are more powerful than a laptop was a decade ago. The user device 114 may include an application 130. The application 130 may run on the user device 114. In exemplary embodiments, the application 130 includes a cloud application relying on cloud computing for its support.

Cloud application services may deliver software to the user device 114 as a service over the network 136 (e.g., the Internet), eliminating the need to install and run the application 130 on the user device 114 and simplifying maintenance and support. Cloud computing services may be provided to facilitate management of the application 130 from the data center 120, rather than at each client's site, and enable users to access the application 130 remotely via the network 136. These services provided by the data center 120 may include centralized feature updating, which obviates the need for downloadable patches and upgrades. The user device 114 may be decoupled from other devices and there may be no sharing of memory and Processes between the user device 114 and other user devices. This in turn allows software designers to have as few dependencies as possible, thereby reducing the risk of malfunction in one part of a system when the other part changes. A client may be able to manage the application 130 remotely via the client device 132.

The data center 130 may provide a computing platform and facilitate deployment of the application 130 without the cost and complexity of buying and managing the underlying hardware and software layers. Cloud service providers may bill such services on a utility computing basis and the amount of resources consumed (and, therefore, the cost) will typically reflect the level of activity.

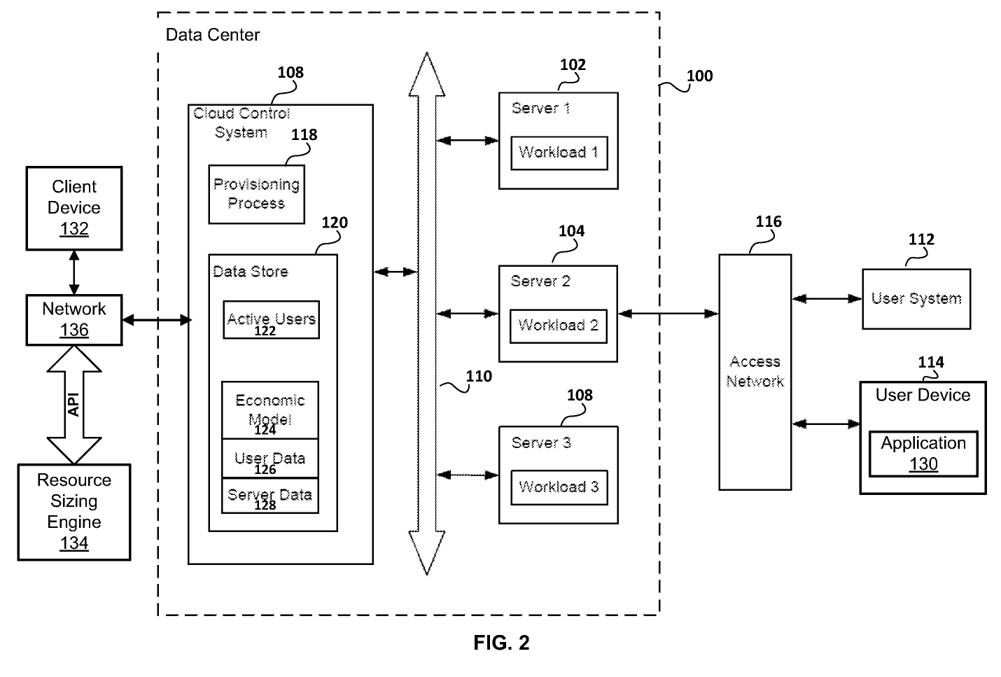

A resource sizing engine 134 may enable clients to buy only those resources they need most of the time. To this end, an API may be provided that includes certain semantics allowing a client to define quality of service requirements and overall architecture functionally. For example, the client may specify a desired response time and an overall architecture including load balancing, firewalls, application servers and databases of certain types without specifying particular sizes of the resources. In response, the system may provide appropriate sizes of the resources and guarantee a certain quality of service. The resource sizing engine 134 is described in more detail below with reference to FIG. 2.

FIG. 2 shows a cloud environment within which systems and methods described herein are implemented, according to various embodiments. As shown, the cloud environment may include a data center 100. The data center 100 may in turn include servers 102, 104, and 108 (also designated as Servers 1, 2, and 3), and a cloud control system 108, according to one embodiment. Data center 100 manages the hardware resources (e.g., processor, memory, and/or storage space) of servers coupled by network 110 (e.g., a local area or other data network) or otherwise.

Customers or users of data center 100 may access the services of the cloud via a user system 112 (e.g., a website server) or user device 114 (e.g., a phone or Personal Digital Assistant (PDA) running an API. User system 112 and user device 114 couple to data center 100 using an access network 116 (e.g., the Internet or other telecommunications network). The user device may include an application 130. Access network 116 may communicate, for example, directly with server 104 or with another computing device in cloud control system 108.

Each of many potential customers (e.g., hundreds or thousands) may configure one or more virtual machines to run in data center 100. Each virtual machine runs one or many processing workloads of a customer (e.g., serving a website, etc.), which places processing and other demands on the resources of data center 100. For example, Server 1 handles processing for a Workload 1, as illustrated in FIG. 2.

For example, a user may access data center 100 by going to a website and ordering a virtual machine, which is then provisioned by cloud control system 108. Then, the user has a private API that exists on all of their services. This will be made public to the customers of the user, and the user can use an API to interact with the infrastructure. Every system may have a “public” interface, a private interface, an administrative interface and a storage interface. This is reflected, for example, from switch to port to Network Interface Controller (NIC) to physical interface to logical interface to virtual interface.

Each virtual machine uses a portion of the hardware resources of data center 100. These hardware resources include storage and processing resources distributed onto each of the plurality of servers, and these resources are provisioned to handle the virtual machines as minimally specified by a user. Cloud control system 108 dynamically provisions the hardware resources of the servers in the cloud during operation as the cloud handles varying customer workload demands. Cloud control system 108 may be implemented on many different types of computing devices, such as dedicated hardware platform(s), and/or may be distributed across many physical nodes. Some of these physical nodes may include, for example, one or more of the servers 102, 104, and 106 or other servers in data center 100.

A plurality of messages is sent amongst Servers 1, 2, and 3 (and, for example, potentially hundreds of other servers). These messages may be sent within a messaging architecture of data center 100 (e.g., controlled by cloud control system 108), as described further below. A portion of the messages sent from any given server includes status information regarding a hardware resource utilization status of that server. Cloud control system 108 analyzes this information and uses decision-making logic (e.g., decision engines) to implement resource provisioning changes as workload demands may vary. These provisioning changes may be implemented by a partitioning process running on each server in data center 100.

Cloud control system 108 detects a request from a first virtual machine of a customer to handle a workload requiring increased use of the hardware resources in the data center 100 (e.g., a significant, but only temporary, increase in data input/output (I/O) to a hard drive or other memory storage in data center 100). This increased demand often may impact the handling of workloads for other customers.

Cloud control system 108 assesses the overall status of the cloud resources (e.g., extent of current utilization as required by workloads for the various virtual machines of the cloud customers) and uses one or more decision engines to implement provisioning changes. This may be done by provisioning the servers (e.g., by a provisioning process 118) to temporarily allocate additional hardware resources on one or more servers in data center 100 to the first virtual machine. This provisioning may be based in part on status information provided by one or more messages received by cloud control system 108. For example, if workloads for virtual machines of other users are only placing low demands on the data center 100, then cloud control system 108 may send out one or more messages to shift or allocate more resources to the high-demand workload.

Cloud control system 108 includes data store 120 (e.g., one or more database (DB) servers). Data store 120 may store information regarding active users 122 of the cloud. Data store 120 may further store information used by the decision-making logic or engines when making provisioning changes, including an economic model 124 (e.g., regarding the cost of various hardware resources), historical user data 126 (e.g., regarding prior workload characteristics and demands as observed in data center 100), and server data 128 (e.g., regarding resource utilization data, past and/or present, for the servers in the cloud). In one embodiment, the information in data store 120 has been communicated by messages received from the servers in data center 100.

In one embodiment, economic model 124 may associate an economic value to the storage and processing resources. The provisioning to allocate additional resources to a virtual machine may be based at least in part on the economic value associated with the storage or processing resources that are available for use by the virtual machine.

In another embodiment, each of a plurality of workloads corresponds to one of a plurality of users of the data center. User data is stored for each respective user, and the user data includes data regarding the behavior of prior workloads handled by the data center for the respective user. The provisioning of the servers to temporarily allocate additional resources to a workload includes correlating system calls for a server to user data for a user having a workload being handled by the server.

In one embodiment, a plurality of workloads being handled by a plurality of servers in data center 100 are monitored, with each server providing one or more shared hardware resources for data center 100, and each of the workloads using at least one of these shared hardware resources. Workload 1 is using a first shared hardware resource of Server 1.

Cloud control system 108 detects a high demand placed by Workload 1 upon Server 1. This high demand may be determined to exist when its demand is greater than an average demand of other workloads being handled by the Server 1. In response to detecting this high demand, a message is sent by system 108 commanding, e.g., Server 1 to move the Workload 1 from the first shared hardware resource to a dedicated hardware resource of Server 1.

The monitoring of the workloads above may include executing one or more agents on each of the servers in data center 100. One agent may include a process that monitors utilization of system resources on Server 1, and the agent reports server utilization data to cloud control system 108 using one or more messages in the messaging system described herein. The decision by a decision engine to move Workload 1 to a dedicated hardware resource may be at least in part based on economic model 124 and/or on an analysis of server resource data (e.g., server data 128) and historical user data 126.

In one embodiment, users or customers are the top level of the networking namespace in data center 100. The activities are segmented into administrative and data networks (not accessible by the customers), and both public and constrained private networks are provided to the customers. The network stacks are locked down so they cannot be modified within a virtual machine, they cannot spoof Media Access Control (MAC) addresses, and they cannot sniff networking traffic.

In one embodiment, the management of resources in data center 100 may be viewed as the management of compute, networking and data resources, which may be broken down and viewed as three “commodities” and three “utilities” to be managed. The three commodities are memory space, processor space, and storage device (e.g., disk) space, and the three utilities are memory I/O, network I/O and storage device I/O. One of the more significant capacity-planning commodities is memory space, and processor space is configured to fluctuate according to a fair share scheduler and reasonable CPU caps with the persistent option of the assignment of single or multiple processing cores to a given virtual machine or workload. Use, for example, of a UNIX system distribution allows large 64-bit memory spaces to be addressed (note in contrast that a 32-bit OS can only address 4 GB of memory).

In alternative embodiments, the provisioning and shifting of a workload by cloud control system 108 may shift the workload from a first shared resource to a second shared resource. In this alternative embodiment, it is not required that the workload be shifted to a dedicated resource. Cloud control system 108 may be generally used for provisioning resource demands by workloads, including, in some embodiments, the provisioning of only shared hardware resources.

The cloud environment may further include a client device 132, a resource sizing engine 134, and a network 136. The resource sizing engine 134 may utilize time as a common unit for describing latency within the compute layer of the servers 102, 104, and 106. Instead of attempting to determine performance of a particular collection of resources based on their respective utilizations, such as the percent Central Processing Unit (CPU) utilization, the resource sizing engine 134 may determine the time it takes for workloads to be executed on server processors. Within the compute layer, multiple operations performed by processors may be utilized to determine the latency of those operations as the application 130 is running on the user device 114. For example, a real-time game may be played on the user device 114 while calculations are performed within the compute layer. The latency-based metrics may allow the performance comparisons of various collections of resources across the same or different platforms using the same set of latency based metrics.

In some embodiments, the systems and methods for sizing resources in a cloud-based environment may be used in conjunction with a content delivery network (not shown). A content delivery network is a system of computers, which may contain copies of data, placed at various points within the network 136 to maximize bandwidth for access to the data from the user device 114 throughout the network 136. The user device 114 may access a copy of the data near to the user device 114 (as opposed to, for example, all user devices accessing the same server 102) to avoid bottlenecks near the server 102. However, a content delivery network may only evaluate the network latency but not the latency at the compute layer of servers. Thus, the systems and methods described herein may be used to determine and guarantee the latency of a content delivery network.

A client may specify, via the client device 132, what components need to be implemented within the data center 100, such as a webserver, a database, the runtime environment and so forth. The client may define the system architecture in functional terms by stating how various components of the system interact with each other and by identifying the tiers. The client may also define relations between various components of the architecture but does not need to provide specific sizes of these components.

Once the tiers and components are identified, the latency analysis may be performed based on a real workload (for example, the workload within the server 102) with time and latency based units. Based on the latency analysis, the resource sizing engine may determine the minimal sizes of the components. For example, instead of selecting 4 CPUs for each application server on 40 machines required for a peak load, the client may be able to select just one CPU for each machine and still guarantee a typical level of service. During a peak load time, the system may provide for bursting the performance up to 160 CPUs.

Once the architecture is defined and the sizes of the components are determined, the architecture may be described in an API by the resource sizing engine 134 and sent to the cloud control system 108 for configuration via the network 136. Based on the API, the cloud control system 108 may provision the resources and their relationships within the data center 100. The API may be written in Extensible Markup Language (XML) file or JavaScript Object Notation (JSON).

The disclosure includes methods and apparatuses that perform these methods, including data centers, clouds, or other data processing systems, and computer readable media containing instructions which, when executed on data processing systems, cause the systems to perform these methods. Various embodiments are described below in which processing, storage, and/or other resources of servers in the network are monitored, managed and/or provisioned to operate a data center, for example, having multiple users with unpredictably varying computing demands. Other features will be apparent from the accompanying drawings and from the detailed description, which follows below.

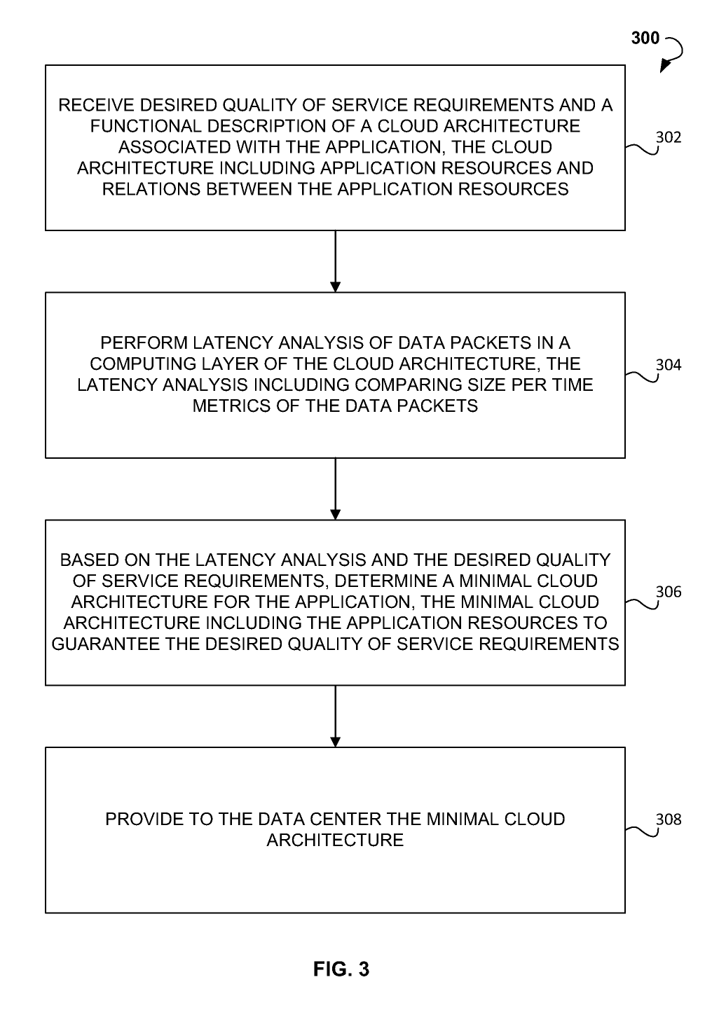

FIG. 3 shows a method 300 for sizing application resources in a cloud-based environment according to one embodiment. The method 300 may commence at operation 302 with the resource sizing engine 134 receiving quality of service requirements and a functional description of a cloud architecture from the client device 132 operated by a client. The quality of service requirements may include availability, performance, and a minimal uplink guarantee for a cloud application. The functional description may include application resources and relations between the application resources. The quality of service requirements and a functional description of a cloud architecture may be directed to a cloud application supported by the data center 100. The cloud application may run on the client device 132, which may include a tablet-type device such as an iPod Touch, iPhone, iPad and the like. Client devices may be of varying sizes and operated by a touch screen or by other means, for example, via a peripheral device enabling users to control and interact through a natural user interface using gestures and spoken commands. Cloud application may rely on cloud computing for application support.

The functional description provided by a client may include tiers of the cloud architecture, wherein the presentation, the application processing, and the data management are logically separate processes. The cloud architecture may include load balancers, firewalls, web servers, application servers, databases, runtime environments and similar tools that support application development and delivery. These tools may be integral to the architecture based on XML, SOAP, Web services, and service-oriented architecture. While core kernel functionality may be provided by the operating system itself, some functionality previously provided by separately sold middleware may now be integrated in the cloud environment. In some embodiments, the client may not need to describe functional description of the cloud architecture. Instead, the cloud architecture may be determined based solely on the quality of service requirements.

Cloud computing services may facilitate management of cloud applications from central locations, rather than at each customer's site, and enable customers to access applications remotely via the Internet. These services may include centralized feature updating, which obviates the need for downloadable patches and upgrades. Oftentimes, the client devices are decoupled from other devices and there is no sharing of memory and processes between devices. As stated previously, this allows software designers to have as few dependencies as possible, thereby reducing the risk of malfunction in one part of a system when the other part changes. These data centers may provide a computing platform and facilitate deployment of applications without the cost and complexity of buying and managing the underlying hardware and software layers. Suppliers typically bill such services on a utility computing basis and the amount of resources consumed (and, therefore, the cost) will typically reflect the level of activity.

At operation 304, the resource sizing engine 134 may perform latency analysis of data packets in a compute layer of the cloud architecture. The latency analysis may include comparing size per time metrics of the data packets. In some embodiments, the latency may be determined empirically by observing a workload of the application while the application is running on a user device. The latency analysis may be performed within a virtual environment and be based on kernel statistics. In exemplary embodiments, the kernel statistics may include active processes, a total virtual memory size, and a number of hard disks used. The latency analysis may provide information needed to size the resources and to support a cloud application given quality of service requirements.

Based on the latency analysis and the desired quality of service requirements, at operation 306, the resource sizing engine 134 may determine a minimal cloud architecture for the application. The minimal cloud architecture may include the application resources to guarantee the desired quality of service requirements. At operation 308, the resource sizing engine may provide to the data center 100, via an API, the minimal cloud architecture. In various embodiments, the minimal cloud architecture may be provisioned by the data center 100. The API may be written in one or more of an Extensible Markup Language (XML) file and a JavaScript Object Notation (JSON) file. In some embodiments, the technology described herein may be utilized to guaranty content delivery within a content delivery network such as, for example, provided by Akamai Technologies.

While the cloud architecture operates on minimal resources, a request may be detected from a first of the respective virtual machines to handle a workload requiring use of the hardware resources that exceeds at least one of its respective minimum specifications (e.g., a large database workload may require intensive access to storage devices or system memory). The data center responds by provisioning one or more of the servers as necessary or desired to provide additional hardware resources to the first respective virtual machine. The minimum specifications provided above may further include a minimum data I/O rate for the storage space and, optionally, also minimums for network I/O and memory I/O.

In various embodiments, when a high demand workload is detected, to provision processor capacity, moving the workload comprises specifying to an operating system of a first server that processing for the workload is to be changed from the shared processor core to the dedicated processor core. As discussed herein, a process on each server may, for example, monitor utilization of system resources on the respective server to provide utilization data, and provisioning to provide the additional hardware resources is performed at least in part based on the utilization data. This provisioning may be limited as necessary in order to maintain the minimum specifications for the virtual machines of other users in the data center.

In exemplary embodiments, when a user initially requests a virtual machine, the data center identifies storage devices of each of the plurality of servers that are available for use by the data center. The servers are provisioned to provide the additional hardware resources by allocating, for example, available storage devices to the virtual machine. Each user may, for example, be provided a common API for operation of its respective virtual machine. One or more calls may be received from the API, with the call being directed, via the data center, to a process already running in a virtual machine of the user.

According to certain embodiments, each user is provided a report regarding usage by its virtual machine of the hardware resources. After providing the report, the data center may receive a request from the user to upgrade its respective minimum specifications for its virtual machine. The data center then provisions the plurality of servers to provide the upgraded respective minimum specifications per the user's request. The user report may also include a suggestion for an upgrade to the respective minimum specifications for the first virtual machine based on the reported usage.

A user's virtual machine(s) may be controlled through a user interface provided to the user. In addition, subsequent to provisioning to provide the additional hardware resources to a user's virtual machine, the data center may receive upgraded minimum specifications from the user. The data center then provisions the servers to provide the upgraded minimum specifications. In addition, the user may, for example, otherwise customize the provisioning for its virtual machine.

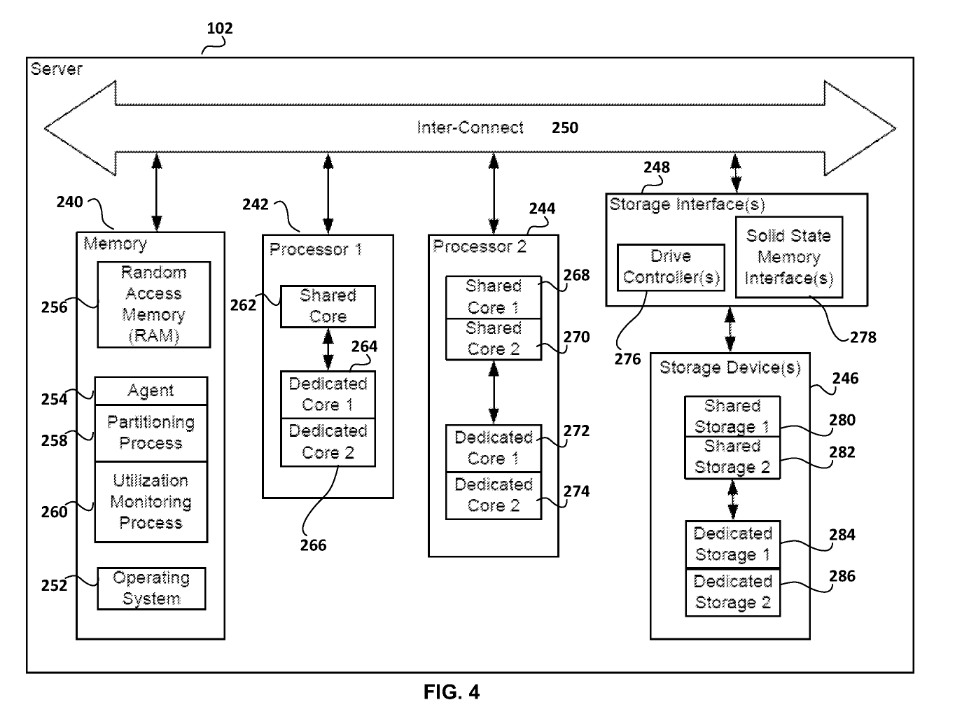

FIG. 4 shows Server 1 (i.e., server 102) of data center 100 in more detail, according to one embodiment. Server 102 includes memory 240, physical processors 242 and 244, and one or more storage devices 246 (e.g., one or more hard drives or solid state drives), each of which may be coupled for internal data communications by inter-connect 250 (e.g., an internal system bus). Storage device 246 may be coupled to inter-connect 250 by one or more storage interfaces 248, which may include, for example, drive controller(s) 276 and/or solid state memory interface(s) 278.

Storage device 246 may be partitioned into shared and dedicated storage spaces. These may include shared storage spaces 280, 282 and dedicated storage spaces 284, 286. These shared storage spaces, in this embodiment, handle storage needs for several workloads that are running in data center 100 (e.g., in one or more virtual machines of customers). If a high demand for storage capacity is detected for any given one of these workloads, then one or more of dedicated storage spaces 284 and 286 may be used to temporarily handle the storage resource needs for the high demand workload. In one embodiment, the storage needs for the workload are completely shifted to a dedicated storage resource (e.g., to avoid interfering with handling of storage needs for other workloads being handled by storage device(s) 246).

In one embodiment, the storage of files in a storage device 246 is handled by a file system (e.g., the Zettabyte File System (ZFS)) file system designed by Sun Microsystems using a multithreaded ZFS send-receive). More specifically, provisioning the servers to temporarily allocate additional storage resources to a first workload includes moving the first workload from a shared storage resource to a dedicated storage resource of a first server of the plurality of servers by specifying to the file system for the storage device that data storage for the first workload is to be handled by the dedicated storage resource (e.g., a dedicated logical Solid-State Drive (SSD)). The file system may be programmed from an API running on a user's computing device.

In another embodiment, the shared storage resource is a first pool under the file system within which a plurality of virtual machines of other users are running, and the dedicated storage resource is a second pool under the file system. The second pool stores at least a portion of files associated with the first workload prior to moving the first workload to the dedicated storage resource. As an example, the first pool includes at least four drives in a Redundant Array of Independent Disks (RAID) configuration, the second pool comprises at least two drives, and the second pool is operating as a mirror of the first pool. The file system may provide a combined file system and logical volume manager that implements snapshots. In one embodiment, the file system is the ZFS file system, and each server in data center 100 uses the ZFS file system.

As a specific example in one embodiment, the file system can function like a RAID card and comparably implement the same functionality with a key difference: data center 100 is configured so that the file system may be accessed programmatically. The file system can, for example, see 12 drives. The drives within the file system can be arranged in pools. For example, eight drives can be put into a single pool that is implemented in a RAID configuration. Then, two drives can be put into a mirror, and another two drives can be put into a mirror.

A virtual machine (sometimes referred to herein as an “accelerator”) is itself supported by a storage pool/file system. The virtual machine is on a file system on one of these pools. For example, the eight drive pool has eight virtual machines running on it, each one is a file system within that pool on those eight drives, and one customer's file workload has been identified to be significantly impacting the other workloads in that pool.

Here, the eight drives are formed together into a pool. There are another two spindles that are formed together into their own pool and they are mirrored across. The file system that is in pool number one is shifted to pool number two. This is treated like the copying of the file system from one place to another, but here the file system completely encapsulates a bootable virtual machine. After shifting, the file system is the only file system on pool two (e.g., having two spindles). Each storage pool can be bound to a particular pool. This type of scheduling can occur without having to reconfigure the underlying pools.

In one embodiment, the RAID structure (e.g., the equivalent of RAID1 or RAID6) is implemented in software rather than in hardware. This permits the RAID structure to be accessed and re-programmed without the use of hardware cards.

Memory 240 corresponds to system memory for server 102. The system memory is addressed by physical processors 242 and 244. Memory 240 typically includes, for example, random access memory 256 (e.g., DRAM and/or SRAM). As discussed above, one or more software agents 254 may be executing on server 102. These agents may include partitioning process 258 and utilization monitoring process 260. Memory 240 also typically includes an operating system 252 (e.g., the Solaris OS from Sun Microsystems).

Processor 242 includes a shared core 262 and also dedicated cores 264, 266. The shared and dedicated cores each provide a logical processor for physical processor 242. If simultaneous multi-threading is, for example, used by the processor (e.g., Hyper-threading for Intel Corporation microprocessors), then each core provides two logical processors.

Typically, during operation of data center 100, numerous workloads share processing capacity available from shared core 262. If a workload has a high demand for processing capacity, then processing needs for that workload may be shifted by cloud control system 108 to, for example, dedicated core 264. This shifting may be implemented, for example, by partitioning process 258, which itself responds to a command in one or more messages from cloud control system 108. Utilization monitoring process 260 may periodically send messages to cloud control system 108 to report metrics on the utilization by server 102 of memory, processing, and/or storage capacity (e.g., the demand on storage device(s) 246).

Processor 244 includes shared cores 268, 270 and dedicated cores 272, 274. Similarly as described above, a high demand workload may be shifted from one of these shared cores to one or more dedicated cores (e.g., as determined by information in messages to cloud control system 108). Further, cloud control system 108 may direct the provisioning of dedicated cores from processor 242, similarly as described above. In addition, shared or dedicated processor cores from other servers in data center 100 may be used to support the high demand workload.

In one embodiment, each server in data center 100 has one or more physical processors providing a plurality of logical processors including a shared logical processor and a dedicated logical processor. The dedicated logical processor is configured to operate as a dedicated hardware resource. Each server has system memory accessible by each of the logical processors, and the system memory size is at least four gigabytes of memory for each logical processor in the server. The server further has a storage device configured to operate as a dedicated hardware resource.

In another embodiment, each respective server of data center 100 includes at least one physical processor providing four or more processing cores, with each core using simultaneous multithreading. Each server includes a system memory size of at least eight gigabytes of memory for each processing core, and each server includes at least one hard disk drive (HDD) having a portion configured to provide a shared storage resource. Each server also includes at least one solid state drive (SSD) having a portion configured to provide a dedicated storage resource. In this embodiment, the SSD capacity is at least 35 percent of the HDD capacity, and the total memory size of the system memory is at least ten percent of the combined HDD capacity and SSD capacity.

In one embodiment, a server may shift a workload from a shared core to a dedicated core. The concepts of a processor (CPU) under a fair share scheduler are coordinated with a cap, as well as the ability to dedicate a specific CPU for the sole use of a virtual machine. The flow is to put a virtual machine under a “share cap” that is, for example, 95% of the CPU resources available and then a share. That share could be expanded to consume an entire CPU as a minimum guarantee, and then the processes in that virtual machine can be instructed to either float that share across multiple logical processors or only be executed on one processor.

Cloud control system 108 also in general may monitor I/O rates for each server regarding high demand I/O rates placed by a workload on system memory I/O, storage device I/O, and network I/O. These I/O rates may be communicated by messages within cloud control system 108 as discussed below.

In one embodiment, each storage device (e.g., each SSD) has a data I/O rate of at least ten megabytes per second for each gigabyte of system memory. For example, each server may have at least one physical processor providing four or more processing cores, system memory of at least four gigabytes of memory for each processing core, and at least one SSD having at least a portion configured to provide the dedicated storage resource. Each SSD has a data I/O rate of at least ten megabytes per second for each gigabyte of system memory.

In another embodiment, each server has a HDD to provide shared hardware resources, and an SSD including at least five logical drives configured to shift back-and-forth between operation as a shared resource or as a dedicated resource as requested during operation of data center 100.

In yet another embodiment, each server has a plurality of logical SSDs, with each drive being individually addressable by a virtual machine supported by the server. The provisioning to allocate additional resources includes allocating at least one of the logical SSDs to the respective virtual machine.

With regard to server design and selecting a memory-to-core ratio for use in one embodiment, most CPUs have an inherent bus speed and memory pipe size. Other considerations are closely spaced memory in a dense environment and heat considerations. In addition, cost considerations are relevant to the memory-to-core ratio. The ratio may be expressed as gigabytes (GB) of RAM per logical CPU or as GB of RAM per physical CPU (e.g., four gigabytes of RAM per logical CPU or, relative to a core with Hyper-threading, eight gigabytes of RAM per core). With a server having one socket, this is one physical CPU. One socket can have, for example, four cores. The four cores in the system are recognized as eight logical CPUs. As the internal bus speed increases, it is typically preferred to have more memory per logical CPU.

With regard to the I/O rate for the storage devices relative to the system memory capacity on a server in one embodiment, the minimum ratio is about 10 megabytes per second per one gigabyte of system memory. It is typically desirable that this rate be greater than this. For operation below this ratio, for example if an application is heavily processing a database, then there is typically some deadlocking of files on the disk or other storage device. From observation, an unexpected result is that this deadlocking is not merely a gradual degradation, in which the handling of other workloads on the server becomes slower. Instead, the handling of these workloads tends to substantially stop working effectively as needed to meet user or customer real-time processing needs.

The use of various storage devices (e.g., SSD vs. hard drive) in one embodiment does not affect the above minimum ratio. Each SSD and hard drive has a different I/O rate. An SSD may have a rate of 180 megabytes per second. In contrast, a hard drive may have a rate of 40 megabytes per second. Therefore, there are different rates per storage device (e.g., hard drive spindle) with different latency and access speeds.

The foregoing is generally the same whether non-volatile RAM or flash memory-based RAM is used. SSDs are typically flash memory-based, but are used in the same profile as a hard drive. For example, a four-tiered “memory” system may be used with a range of persistent and performance states: traditional DRAM, flash card non-volatile RAM (e.g., “SSD” in a “RAM” form factor), SSD with an SAS/SATA form factor/interface, and actual SAS/SATA drives.

So, for example, if a socket on a server has eight or 16 cores, and the server has 128 or 512 gigabytes of RAM, then the server may need to use SSD or flash memory in order to maintain the 10 megabytes per second I/O per gigabyte of RAM minimum ratio. With Hyper-threading, the ratio is still eight gigabytes of memory per core, or four gigabytes of memory per logical CPU. If Hyper-threading is not available, then at a minimum, the server is kept at four gigabytes of memory per core. If Hyper-threading is available, then it is eight gigabytes of memory per core.

In one embodiment, both SSDs and hard drives may be used on a server. The use of two SSDs for each hard drive is a fairly aggressive ratio. Typically, one SSD spindle replaces ten hard drive spindles (a ratio of 1:10). Other desired ratios may be 1:4, 1:3 or 1:2. The actual storage capacity of each hard drive spindle is not critical. As the larger rotating media drives get full, the performance in actually finding data on the drive decreases significantly. This problem becomes more significant in a disproportionate way as the drive size increases. For example, 190 gigabytes of data on a 200 gigabyte drive can be searched faster than 900 gigabytes of data on a one terabyte drive.

It is typically desirable, for example, to have dozens of smaller disk drives because the factor that limits the I/O throughput is the I/O capacity per drive. For rotating media, the I/O capacity is proportional to the number of spindles. Using a large number of small disk drives in this fashion is in contrast to the conventional approach of aggregating this storage capacity into a single large drive.

In one embodiment, a server has at least one SSD for every processor core. In addition, the physical SSD to logical SSD ratio may be, for example, either 1:1 or 2:1. They are either kept as a mirrored RAID1 pair of SSDs or a single SSD containing what are considered to be transient or temporary data.

With regard to desired memory storage capacity per processor core in one specific example, a typical relational database may have 10% of its data being actively used. Thus, for a 640 gigabyte database, 64 gigabytes of RAM is desired. Therefore, a minimum capacity core ratio would be one core: 4 GB RAM: 40 GB disk space for handling this relational database workload. To further explain these ranges, when the data is 100% active, then effectively up to 100% of memory usage is desired. When the data is 0% active, then only on-disk storage is needed. Cloud control system 108 may dynamically modulate resources across these three states, and overlay customers having different demand needs at differing, unpredictable times. For example, considering CPUs, a two socket server with four cores per socket, with Hyper-threading on 16 logical CPUs, is served by at least 64 gigabytes of RAM. This system should have 640 gigabytes of disk storage capacity on the server. Therefore, if there are 64 gigabytes of RAM, there are 640 gigabytes of disk space.

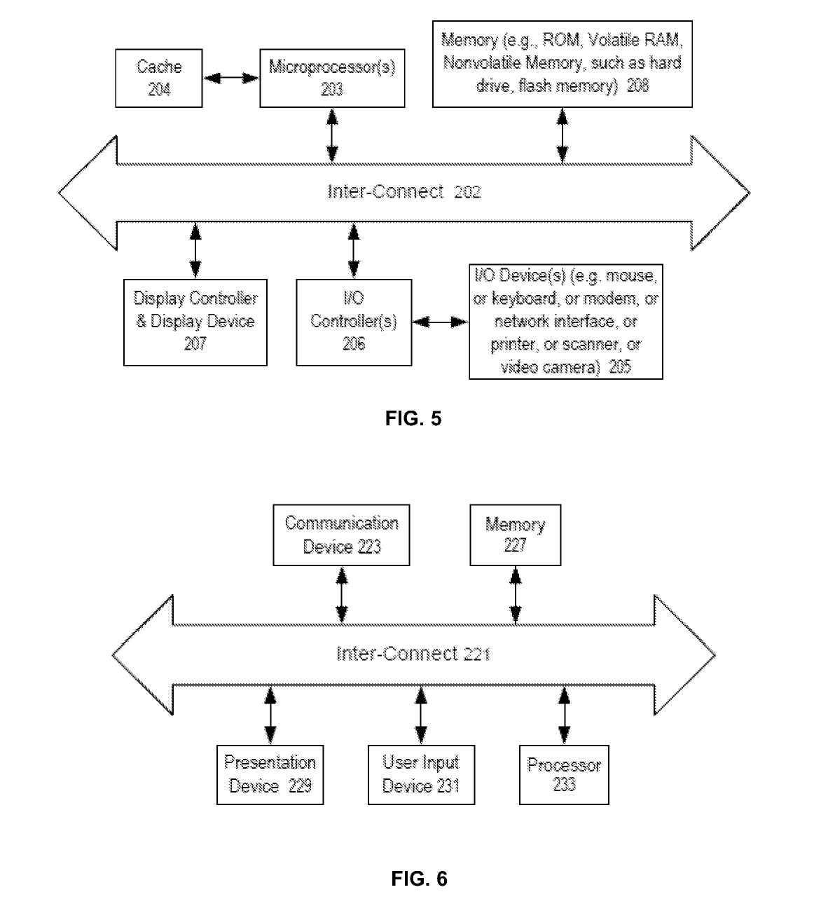

FIG. 5 shows a block diagram of a data processing system, which can be used in various embodiments. While FIG. 4 illustrates various components of a computer system or computing device, it is not intended to represent any particular architecture or manner of interconnecting the components. Other systems that have fewer or more components may also be used.

In FIG. 5, the system (201) includes an inter-connect (202) (e.g., bus and system core logic), which interconnects a microprocessor(s) (203) and memory (208). The microprocessor (203) is coupled to cache memory (204) in the example of FIG. 5.

The inter-connect (202) interconnects the microprocessor(s) (203) and the memory (208) together and also interconnects them to a display controller and display device (207) and to peripheral devices such as input/output (I/O) devices (205) through an input/output controller(s) (206). Typical I/O devices include mice, keyboards, modems, network interfaces, printers, scanners, video cameras and other devices, which are well known in the art.

The inter-connect (202) may include one or more buses connected to one another through various bridges, controllers and/or adapters. In one embodiment the I/O controller (206) includes a USB (Universal Serial Bus) adapter for controlling USB peripherals, and/or an IEEE-1394 bus adapter for controlling IEEE-1394 peripherals.

The memory (208) may include ROM (Read Only Memory), volatile RAM and non-volatile memory, such as hard drive, flash memory, and the like.

Volatile RAM is typically implemented as DRAM, which continually requires power in order to refresh or maintain the data in the memory. Non-volatile memory is typically a magnetic hard drive, a magnetic optical drive, an optical drive (e.g., a DVD RAM), or other type of memory system that maintains data even after power is removed from the system. The non-volatile memory may also be a RAM.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In one embodiment, a data processing system as illustrated in FIG. 5 is used to implement a server in the data center above.

In one embodiment, a data processing system as illustrated in FIG. 5 is used to implement a user terminal, which may provide an API to a cloud customer. A user terminal may be in the form of a PDA, a cellular phone, a notebook computer or a personal desktop computer.

In some embodiments, one or more servers of the system can be replaced with a network of distributed computing systems. The distributed computing system can be collectively viewed as a server data processing system.

Embodiments of the disclosure can be implemented via the microprocessor(s) (203) and/or the memory (208). For example, the functionalities described can be partially implemented via hardware logic in the microprocessor(s) (203) and partially using the instructions stored in the memory (208). Some embodiments are implemented using the microprocessor(s) (203) without additional instructions stored in the memory (208). Some embodiments are implemented using the instructions stored in the memory (208) for execution by one or more general purpose microprocessor(s) (203). Thus, the disclosure is not limited to a specific configuration of hardware and/or software.

Additional example networked and distributed computing environments, and an example computing device, are described in United States Patent Application Publication US 2009/0092124, published Apr. 9, 2009 (titled “NETWORK ROUTING OF ENDPOINTS TO CONTENT BASED ON CONTENT SWARMS”; inventors Singhal et al.; assignee Microsoft Corporation; application Ser. No. 11/866,811, filed Oct. 3, 2007), which is hereby incorporated by reference in its entirety.

FIG. 6 shows a block diagram of a user device, according to one embodiment. In FIG. 6, the user device includes an inter-connect (221) connecting the presentation device (229), user input device (231), a processor (233), a memory (227), and a communication device (223). The communication device (223) is configured to communicate with a telecommunications network. The user input device (231) may include a text input device, still image camera, video camera, sound recorder, and so forth.

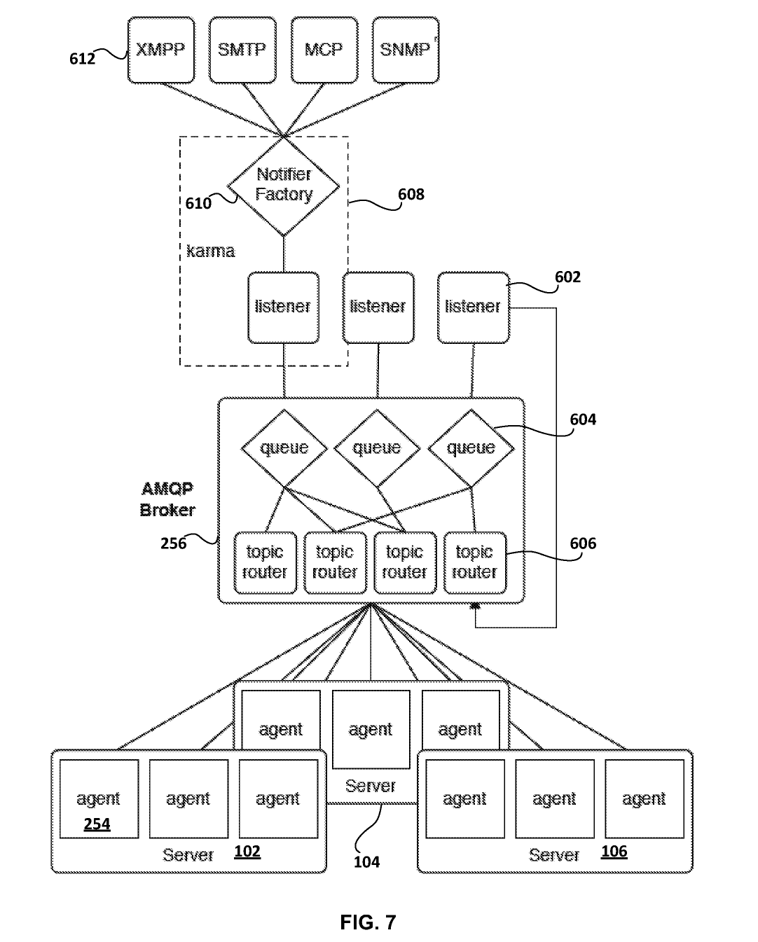

FIG. 7 shows a messaging system architecture for data center 100, according to one embodiment. The messaging system architecture generally includes one or more messaging systems for sending and receiving messages to and from servers in data center 100 (e.g., brokering the sending and receiving of these messages). In this embodiment, the architecture is a hub-and-spoke, distributed message queue system. Messages from cloud control system 108 and the servers are brokered, for example, by an AMQP broker.

In FIG. 7, an AMQP messaging system 600 communicates with each of servers 102, 104, and 106. Agents 254 and other agents on servers 102, 104, 106 and/or other servers in data center 100 send and receive messages to the AMQP broker. Messages received by the AMQP broker each have an associated topic.

The topic association may be made by an agent at a server when sending the message. In one embodiment, the topics available for this association are predefined and stored in data center 100 within cloud control system 108 and on one or more servers. The topics may be further arranged into a topic hierarchy so that listeners 602 may operate to detect messages within a given portion of the hierarchy. In one embodiment, the topic hierarchy is initially defined for operation of the system. After a period of time in which various topics are examined in messages received by cloud control system 108, the topic hierarchy may be updated or changed to reflect the actual type and number of topics received during operation.

The AMQP broker includes one or more topic routers 606 that sort and route these messages into one or more queues 604, depending on the topic. In one embodiment, there is a queue 604 for each topic router 606. One or more listener processes 602 (sometimes simply referred to herein as a “listener”) are running in messaging system 600 and monitor incoming messages to detect messages having a particular topic(s). In one embodiment, each listener 602 has a corresponding different queue 604. In one embodiment, each of one or more queues 604 is stored on a different one of the servers in data center 100, and the predefined topics for queues 604 are stored as a predefined topic hierarchy on two or more of the plurality of servers.

In general, one or more decision engines 608 use decision-making logic to determine how to handle messages received by cloud control system 108. In this embodiment, a decision engine 608 is associated with each listener process 602. Decision engine 608 uses decision-making logic represented in FIG. 7 as a “Notifier Factory” 610. Notifier factory 610 may, for example, include a number of rules to determine subsequent tasks and/or messages to be launched based on a particular message that is received by its corresponding listener 602. For example, notifier factory 610 may send a new message having a type selected from one of a predefined set of message types 612 (for example, messages implemented by XMPP, Simple Mail Transfer Protocol (SMTP), or Simple Network Management Protocol (SNMP)). The message type “MCP” indicated in FIG. 7 designates an API that may be customized for cloud control system 108 to implement all system interactions in a RESTfull API.

In one embodiment, a dedicated agent is executed on each server in data center 100, and each respective agent listens for a dedicated one or more topics from the topic hierarchy. Each dedicated agent sends a stream of messages to cloud control system 108 to update the network regarding the operation of the respective server from which the stream of messages is being sent. The stream of messages is pushed to cloud control system 108, and the stream may be sent periodically. Alternatively, other events may trigger the sending of the messages.

In one embodiment, agents can communicate presence over a chatting protocol (XMPP) and commands over AMQP. When the agents are to execute commands, the agents are instructed as to the commands to locally execute and the data to collect and then send out to the data bus. For example, an agent that collects metric information can reach into kernel stats of the operating system on a server or trace anything with DTrace with its set of executed commands. (DTrace is a comprehensive dynamic tracing framework created by Sun Microsystems for troubleshooting kernel and application problems in real time. DTrace permits inspection of various elements of the kernel and userland at run-time).

Thus, the agent can find out how many system calls the workload is making. The agent is a process and is capable of firing up other processes. It is also possible to achieve versioning of agents. A prior version of a process can be terminated once a task is complete. The metrics collected by the agents are sent, for example, to a central cloud control server.

In another embodiment, as a specific example, a typical instruction in a message from cloud control system 108 (e.g., initiated from notifier factory 610) to a server is in a JSON or XML format (other formats may be used in other embodiments) and everything has a base URL, for example, as follows:

https://api.joyent.com/mcpkversion>/path-that-denotes-an-action

In one embodiment, the HTTP methods GET, PUT, and POST may be used in a RESTful fashion on the API gateway, for example, as in the following:

```
- Show Action
  - Path: /customers/:customer_id
  - HTTP Method: GET
  - Parameters: customer.id
  - Success HTTP Code: 200 OK
  - Response Body:
```

```
- <?xml version=“1.0” encoding=“UTF-8”?>
<customer>
  <id>Integer</id>
  <email_address>somebody@example.com
```

<mailto:somebody@example.com> somebody@example.com
<mailto:somebody@example.com></email_address>

```
<alternate_email_address></alternate_email_address>
  <company_name></company_name>
  <street_1></street_1>
  <street_2></street_2>
  <city></city>
  <state></state>
  <postal_code></postal_code>
  <country></country>
  <phone_number></phone_number>
  <updated_at>YYYY-MM-DD HH:ii:SS</updated_at>
</customer>
```

Some commands such as the above, may only elicit a response from cloud control system 108, while others, such as the following, must be led to a command executed on a specific machine by, in this case, the “reboot agent”:

- Reboot Action

- HTTP Method: PUT
- Optionally, allow method_override with POST + “_method=put”
param
- Path: /customers/:customer_id/accelerators/:accelerator_id/reboot
- Parameters: N/A
- Request Body: N/A
- Success HTTP Code: 200 OK
- Response Body: N/A
- Notes: Only active zones can be rebooted

This restriction of machine agents to a specific task is implemented in the messaging system of cloud control system 108. The API gateway translates this into a message in XML or JSON that is carried out by an agent on a specific machine (e.g., a server in the cloud) into a new message still in XML or JSON format. This new message contains that identifying information and directives called in the API gateway along with the specific actions to be carried out. The new message is then pushed to an agent on the machine similarly, for example, as a Blackberry device pushes email. The new message is consumed, and the action is carried out by the agent. The agent generates a success or failure message, pushes this message into the message bus where it is consumed by cloud control system 108, and the result is noted and recorded (e.g., in data store 120).

In one embodiment, any given message may cause an action or task to be implemented or occur on more than one server or component in data center 100. For example, as a message is distributed, there could be 10 or 15 different components reacting to the message in one way or another.

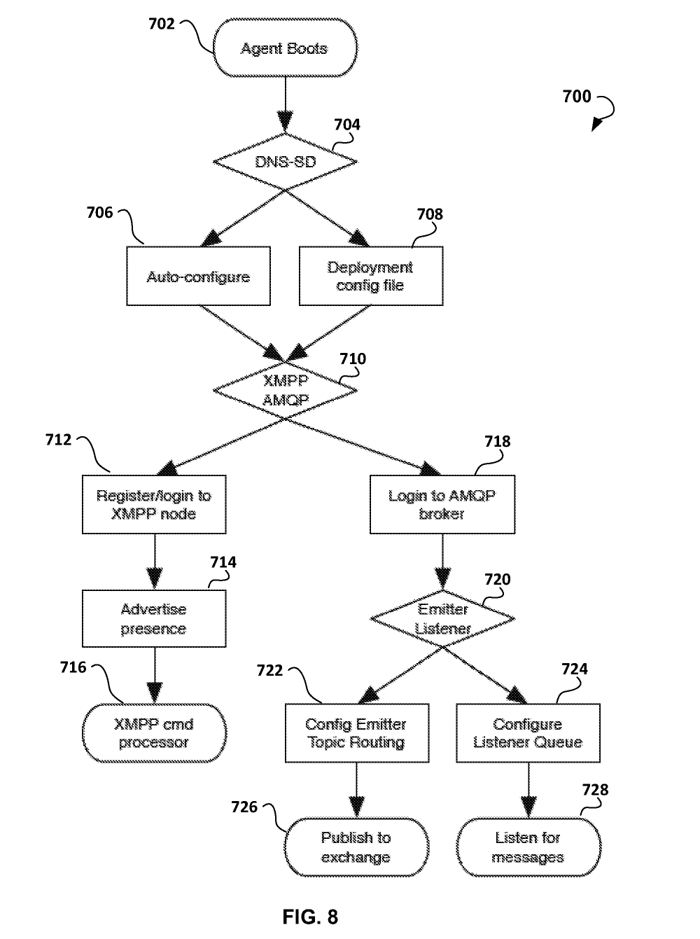

FIG. 8 shows a process 700 for initiating a new agent on server 102 in data center 100, according to one embodiment. A new agent may be initiated, for example, when a new server is being added to the network of data center 100 or when a given resource needs to be segmented and scaled for security and use demands.

At block 702, the new agent boots on server 102. This may be in response to server 102 newly joining the network. At block 704, the new agent does service discovery (for example, DNS-SD) to look for services that are available to the new agent in data center 100. At block 706, the agent does an auto-configuration, and at block 708, the agent deploys a configuration file.

As part of initiation process 700, at block 710, one or more new agents are launched, each for a different messaging system that may be used in cloud control system 108. In this embodiment, one new agent is launched for an XMPP messaging system and one new agent for AMQP messaging system 600.

At block 712, the new XMPP agent logs in to the XMPP system, and at block 714, the agent advertises its presence to cloud control system 108. In this embodiment, cloud control system 108 runs an XMPP messaging process. At block 716, the new XMPP agent launches an XMPP command processor.

At block 718, the new AMQP agent logs into AMQP broker 600, and at block 720, launches an emitter agent and a listener agent. At block 722, the emitter agent is configured to handle topic routing of messages from server 102, and at block 726, the new agent publishes these messages to messaging system 600. At block 724, the new listener agent configures a listener queue and, at block 728, listens for new messages received from AMQP messaging system 600. The listener queue listens and then queues messages, and then the AMQP broker takes what is queued and does an appropriate directing of it.

In one embodiment, a first new agent is initiated on a new server in which the first new agent discovers services in the network available to the first new agent. The first new agent self-configures in response to the services discovered. The first new agent launches a second new agent that logs into a first messaging system (e.g., XMPP) to advertise a presence of the new server, and also launches a third new agent that logs into a second messaging system (e.g., AMQP). The third new agent implements and manages a listener queue on the new server, publishes messages to the second messaging system, and listens for new messages in the listener queue.

In one embodiment of the initial provisioning of a server (e.g., in order to become part of a higher-level modular network unit), an initial or new agent boots, does a zero-conf service discovery (DNS-SD), and then is auto-configured and sent a deployment configuration file. This is used to log into and make one's presence known to the AMQP/XMPP message busses. Using XMPP, the active server then advertises state and presence. Then, the server logs into the AMQP broker, begins to listen for messages that contain commands, and begins to publish its information to the message system exchange.

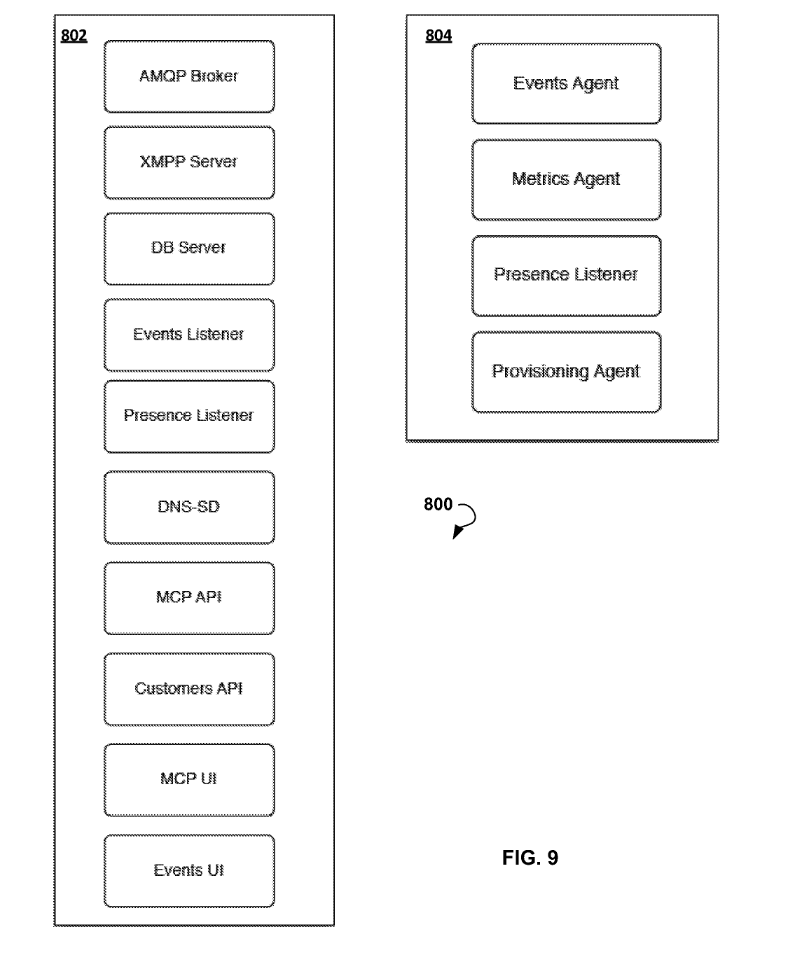

FIG. 9 shows certain base services 800 available in cloud control system 108, according to one embodiment. Client agents 804 (for example, a presence listener or metrics agent) run on server 102 (and also, for example, on the other servers in data center 100).

The metrics agent obtains metrics data for the hardware resource capacity and I/O usage by a server. The provisioning agent listens for messages related to a provisioning topic and then implements partitioning on a server (as described for partitioning process 258 above) as may be commanded by a message.

The presence listener is used to relay the presence and availability of a system. The events agent is used to regulate events by all actions performed on a system.

Cloud control system 108 includes one or more of various services 802, and some of these services may be discovered by a new agent when instantiated. In one embodiment, the database (DB) server(s) may be used to store information for data store 120 (e.g., to keep the state of nodes in the network).

The events listener and presence listener are, for example, two of listener processes 602. The events listener detects events that may trigger an analysis by one or more of a decision engine 608. Listeners 602 may listen for certain topics, and then determine if an event related to that topic has occurred in data center 100.

The XMPP server supports the XMPP messaging system used for certain of the embodiments discussed above. The presence listener is used to relay the presence and availability of a system. The MCP API and MCP UI indicate an API and user interface to a customized API (as discussed above) and are used to coordinate and present all provisioning and system tracking information.

The customers API and UI are used to coordinate and present all information around resources to customers. The events UI is used to present all events and metrics to end users. The DNS-SD service is used by agents to auto-discover available resources and services.

In example embodiments, when a virtual machine is provisioned, it runs on a single physical machine. There are multiple virtual machines running on each physical machine. Any given virtual machine only runs on one physical machine. The cloud control system may be installed on a single machine dedicated to cloud control. Alternatively, the cloud control system can be provisioned within the same virtual machines, and the collection of services can be installed throughout the infrastructure so that cloud control is a distributed set of services.

For example, a virtual machine is to be provisioned somewhere in the data center. A message indicating this is created and dropped into the outgoing message queue. Cloud control system 108 is provided a size of memory by API, and then makes a decision on where that memory is available in data center 100. The new virtual machine will be placed there. The AMQP messaging system is used to look for a machine that has the necessary gigabytes of RAM to implement one or more various specifications (e.g., minimum ratio) as described above. Then, XMPP is used to talk to that particular server. This tells the server to start provisioning, and then to have the server respond with a new message to report when it is done.

Now discussing a specific example of a customer's virtual machine (VM), there are two aspects to the VM. One aspect is the presentation the VM takes to the customer. The other aspect is the presentation the VM takes to the cloud operator. From the customer's perspective, the VM appears like any other Solaris machine. To the operator, the VM appears like a separate set of processes running under an installation of Solaris. In Solaris, every process in the system may be tagged. For example, one process may be tagged for Zone A and another process tagged for Zone B. The processes can be set up so that they do not interact with processes in a different zone. A zone refers to an arbitrary virtual machine. Zone A, for example, would be a virtual machine A running underneath a real machine. Each zone has a one-to-one relationship with a customer (which in some circumstances could be the same customer).

In one specific example of shifting of storage, ZFS is used to shift file systems. ZFS takes a snapshot of a file system that an operator can see at any given moment. Having a snapshot of a file system permits sending it to other machines (each machine is running the ZFS process). Using a previous snapshot, the incremental change that has occurred in the file system can be determined so that moving the file system snapshot requires a smaller data transfer.

The snapshot provides the state of the file system (e.g., files, size, hierarchy, and data). Each customer is running a virtual machine having this same ZFS file system. Once the copy of a customer's virtual machine has been copied to another machine, the virtual machine can next be moved to the new machine more readily. Another snapshot is taken, and then an incremental copy is done to update the snapshot on the new machine to complete the transfer. Finally, the customer's virtual machine is restarted on the new machine.

In this description, various functions and operations may be described as being performed by or caused by software code to simplify description. However, those skilled in the art will recognize that what is meant by such expressions is that the functions result from execution of the code by a processor, such as a microprocessor. Alternatively, or in combination, the functions and operations can be implemented using special purpose circuitry, with or without software instructions, such as using an Application-Specific Integrated Circuit (ASIC) or a Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system, middleware, service delivery platform, SDK (Software Development Kit) component, web services, or other specific application, component, program, object, module or sequence of instructions referred to as “computer programs.” Invocation interfaces to these routines can be exposed to a software development community as an API. The computer programs typically comprise one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places, including, for example, ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of computer-readable media include, but are not limited to, recordable and non-recordable type media such as volatile and non-volatile memory devices, ROM, RAM, flash memory devices, floppy and other removable disks, magnetic disk storage media, optical storage media (e.g., CD ROMS, DVDs, etc.), among others.

In general, a machine readable medium includes any mechanism that provides (i.e., stores and/or transmits) information in a form accessible by a machine (e.g., a computer, network device, PDA, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

Although some of the drawings illustrate a number of operations in a particular order, operations, which are not order dependent, may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

### User Management

### Goals

High-Level Overview

User Stories

### Definitions

Account
Organization

User

UserGroup

Role
Role Indexing

### Logical API

Accounts

Users

UserGroups

Roles

### Zone/OS Updates

### Proposed Defaults

### Example Usage Guide

### Public API Changes

Scoping

Steps to completion

Step 1—SSH Authentication

Step 2—Resource Permissions

Step 3—Organizations and API Permissions

### Open Questions

### Abstract

This document describes the approach to identity management for the public API and zone provisioning. This serves as a first pass approach at how we will be able to build in richer account/user/group/permission hierarchies into the API, provisioned zones, and node applications.

### Goals

### High-Level Overview

The way to get your head around this is to look at the end state we want to get to, and then look at the details along the way that get us there. The end state we want to have is a completely flexible account and security system whereby customers can create whatever identity mapping they want into their organization for management of infrastructure/applications via the API, true integration of those identities in both the OS and their applications (think PAM and JAAS, but not sucky), and the ability to turn around and easily resell infrastructure/applications to their customers without reinventing all the requisite abstract security components.
In order to deliver that set of goals, we are going to enhance the existing system to support “child” users and groups, and eventually enable recursive account-based billing. By enhancing these “child” users, we will be directly managing the login infrastructure on compute nodes (so we'll have custom PAM modules to support our user login), which is a substantial value-add over raw infrastructure (such as EC2).

### User Stories

As a joyent customer, I should be able to . . .

manage my own account (account info, payment methods, sshkeys).

manage my own resources (smartmachines).

give other users access to my resources.

access resources belonging to other customers, provided I have been granted access to such resources.

create an organization.

As a customer belonging to an organization, (as long as my role allows me) I should be able to . . .

manage the organization's account (account info, payment methods)

manage and access the organizations resources (smartmachines)

give other users/accounts access to resources that belong to organizations (smartmachines)

add other users/accounts as members of the organization.

manage roles belonging to the organization.

### Definitions

### Account

An Account is a legally and financially responsible customer. An Account possesses the following properties/semantics:

Usage accrued for all resources created on behalf of the account is ultimately rolled up against the account (i.e., an account gets a single invoice per billing period)

Irrevocable control over any resources created on behalf of the account (through the API; ultimately the account can de-provision anything that has financial or legal implications on the account)

Globally addressable names within the sphere of a single “cloud”

The ability to create delegate entities under it's control (e.g., users: see below)

An account is what exists today in the JPC. Any resource created in the system today is mapped to an account via the uuid that exists today in CAPI.
While an account will enable arbitrary organizational complexity in the fullness of time, we want to offer the average small customer (i.e., an individual) an easy onboarding experience, similar to what they have today. To support this, an account will continue to require contact/payment/security information at creation (i.e., email/cc#/name/password).

### Organization

An Organization is a container subordinate to an Account. An organization exists as a scoping mechanism for an account to carve up resources (for financial reporting and/or security reasons). An organization always belongs to a single account, and can contain users/groups/resources, and in the fullness of time, other organizations. With this mechanism, a customer of Joyent can create whatever arbitrary hierarchy they need to map to their internal org structure. An Organization possesses the following properties:

Naming/Indexing isolation (i.e., “list all my stuff” only shows the resources under a single organization).

Does not possess credentials allowing it to authenticate (an Organization is a container only).

Note that to support these semantics any provisioned resource will need to keep track of the organization to which it belongs in whatever our equivalent of an inode is (so thus far it will need to contain both the account uuid and an organization id). For this reason Organizations will not exist in the 3/31 release, but will be added later (i.e., its too deeply intrusive to the stack to fit in).
Backwards compatibility in the future will be such that an account can act like an organization (since an account has the superset of properties of an organization). We will choose later whether to actually allow an account to be an organization, or to silently create an organization with the same name as the account. Note an account will add a layer of scoping in a resource urn (defined below).

### User

A user in the system is a new entity that exists under a single organization. It is a 1:1 mapping to a POSIX user in a compute node. Additionally, it will support arbitrary attributes on it so customers can attach SSH keys, passwords, contact information, etc. A user will have a unique name/uid/gid per account that it belongs to, but these are not global in the entire system. The ability to address a user globally by name must be done by “fully specifying” it. For example, in the full-on global compute network case, a “mark” under let's say “Orange” (the French cell phone people) under some French SP who for this example has the name “France”, would be urn:france:orange:mark. However, when access mark in the orange account, whether for a POSIX user or for API access control one could just use mark. The full-specificity is necessary to not conflict with accounts named “mark” in the global namespace. Full examples will be given below in the usage example section.
A user will be able to directly login to compute nodes with either a key associated directly against the user, or via a role mapping (see usage examples below).
Note that initially, a user can have the following attributes

name

key

Eventually, we will extend user to support more attributes as we need them, as well as arbitrary customer attributes.

### UserGroup

A usergroup in the system is another new entity that exists solely for mapping into POSIX groups. It is named usergroup solely so that its not confused with some other grouping mechanism. A usergroup simply has a name, which is unique to the account, and a list of users, under the same account.

### Role

A role represents a set of rules mapping permissions from a security principal to a resource (note this is a slight variation from the NIST definition of an RBAC system; personally I don't see why we'd care, but I'm at least calling it out). A rule in a role will be comprised of 3 distinct components:

Subject

Action

Resource

A subject is the security principal who will receive access as a result of being in the role. A subject can be an account, a user, or a usergroup. The case of account or user is relatively straight-forward in that it maps directly to a “single” entity. Usergroups are ultimately more complex, in that the permission will obviously apply to the entire group of users (really it's just complex for us as we'll need richer indexing). Note that account is obviously an entity outside of the current organization's control, and userνusergroup can be either one of the local users or a fully qualified from another organization.
An action is a verby thing that we dictate. For logging into machines we would have some string login. API actions would be something like all, etc. For V1 we'll just have login createAccount createComputeNode.
A resource is an abstract entity in the system, such as a user or computeNode.
Note that a single rule represents a singular mapping from a subject to a resource; however subject and resource can be multi-valued. A set of rules may be in a single role (and in fact probably will be) to support the full set of indirections we need. In terms of determining access grants to a system, it's logically one giant OR operation.
Lastly, since the rules are ultimately string-matching, we will support prefix wildcarding (we can add regex's in time if necessary, but the * character probably covers 99.9% of what we need).

### Role Indexing

Everything outlined above should be pretty straightforward to achieve. With the exception of roles. Roles introduce a degree of complexity to implement since they're a set of persisted rules, and that makes them hard to index (e.g., when do we pull in what rules?). Since roles are ultimately specific to an account, we will index roles for account resources, but index them by the associated subject. In essence, we will treat them as a stored capability. If that didn't make sense, an example might be easier. joyent:kabam:mark has an arbitrarily large set of roles assigned to him (he is popular, ehh?) in many different accounts, including kabam. So that we don't have to evaluate all rules every time mark access the system, we will first look up rules that belong to the account the user is addressing. Secondarily, all rules will be indexed by subject, so we can quickly look up what the rules mark has associated to him (or any groups to which he belongs). So basically well have a set of tables like:
The implication of this is that we actually will not be able to support ‘*’ matching on subjects (or at least not without destroying any DB I know of). We can compromise if customers ask for an anonymous case and allow a special ‘*’ only situation on subjects; in which case for every user authorization event, we would need to look 1+N+1 roles (1 for the current user/account, N for the number of groups they're in, and 1 for the special ‘*’ subject). I propose we not do that in V1 and wait for someone to ask.

### Logical API

Before getting into the REST bindings for the API, it is easier to walk through the APIs from a logical point-of-view to see what is being accomplished. As stated above we are going to add

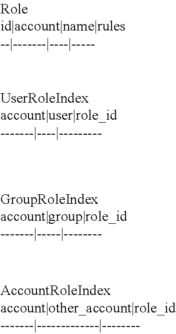

new entities into the system; as a result of that we'll need to change a few of the existing APIs to be rational. Note that we're basically supporting CRUD operations on all the entities described above; there really aren't RPC-style bindings in the stack (note that the PAM modules will run “live”; that is /etc/passwd will be empty, and everything will be resolved at login time).

### Accounts

### Users

Account:

username: bluesnoop
password: ********
email: mark@bluesnoop.com
keys:

- pub1
- pub2

first_name: Mark
last_name: Cavage
company: Bluesnoop.com
address: ...
phone: +1 (206) 555-1212

Account CreateAccount(name, email, password)
Account GetAccount(name)
void UpdateAccount(account)
void DeleteAccount(name)

### UserGroups

User:

name: mark
keys:

- pub1
- pub2

uid: 10001

User CreateUser(name, Key)
User GetUser(name)
void UpdateUser(user)
void DeleteUser(name)

### Roles

UserGroup:

name: developers
users:

- mark
- brock

gid: 10000

Group CreateGroup(name)
Group GetGroup(name)
void UpdateGroup(group)
void DeleteGroup(name)

### Role:

name: unix-users
-rule: subject:
account: sintaxi action: map resource:
user: mark description: “Let sintaxi the account assume the ‘mark’ POSIX user under the ‘bluesnoop’ account”
-rule: subject:
user: mark action: login resource:
smartmachine: * description: “Let the POSIX user ‘mark’ under the ‘bluesnoop’ account login” Role CreateRole(name) Role GetRole(name) void UpdateRole(role) void DeleteRole(name) Zone/OS Updates
The general gist here is that we will forgo all the authorized_keys complexity, and move to a custom PAM module that can authenticate users via live lookup. We're going to install a door between every provisioned zone and the global zone that the PAM module/SSHD can call in order to authenticate a user and get back the id/group/shell/blah information.
In addition to the CRUD APIs that we are supporting to allow customers to provision users/groups, and the ability to update already provisioned machines, we now need to suport a (private) authenticate API that can be called from the global zone. Presumably this is best suited to live in MAPI, since we don't actually need customers to ever see it. What we really want is simply to have the ability to resolve an SSH key id for a public key (i.e., nuke ssh authorized_keys), and upon successful SSH hadnshaking, resolve that key to a full user identity structure that the OS is happy with.

### Proposed Defaults

While the system proposed above (I think) solves all use cases we can envision, it introduces extra complexity that beginning users will not likely need/want. In order to mitigate the complexity, the following set of “defaults” are proposed.
There is no need to create a user named ‘root’. The ‘root’ user is a virtual user that maps to the account.
For the account specifically, all access control checks in the API will be bypassed (when we have access control). Any attempt to add the account to a role under the same account will be rejected. For compute node login, the account sshkey is able to assume any user on the OS that is provisioned (e.g., we will automatically let the account map to any user under the account).

name: root
- rule:

subject:

account: _kabam_{—}

action: map
resource:

user: root

Upon account creation, we will precreate several roles (note they will all contain empty subjects; customers are expected to add whatever subjects they see fit):
Administrators: contains a rule with an action/resource set to ‘*’.
Login: contains a rule with a action set to ‘login’ and resource set to ‘*’. A common pattern for customers will likely be to set the subject. User to * (e.g., all users under the account can login to all machines).
We'll likely have other default roles when we support access control in the API.

### Example Usage Guide

To illustrate how this system accommodates (most) use cases, let's imagine a scenario where there's “individual” developers, as well as corporations (organizations), interacting with this API in the context of a “global compute network”. To build this, let's assume we have a service provider. Underneath the service provider, there is an individual developer sintaxi, as well as an SMB kabam.
So sintaxi comes along and wants to quickly work with machines and let himself and his friend rob who works at kabam use his node machine. sintaxi, like most of the internet population, isn't overly concerned about unix security, so he just maps the kabam account to his (default) user ‘root. sintaxi then creates a role called ‘root’, that has the following rules in it: So sintaxi is now just as happy as can be, assuming he didn't barf all over the role complexity by now. Let's assume that kabam exploded with popularity, and now has several administrators that they maintain as users (that is, these are not ‘paying’ accounts, want no part of the joyent cloud, and want to let kabam manage their world). rob, who is clearly too busy to use sintaxi's node machine calls sintaxi and asks to replace himself with a user mark who works for kabam. Brock updates his role to now be:
Note that sintaxi has now updated the system to allow kabam:mark to use only the user mcavage, on a single node, as opposed to before, when kabam could use root on any system. Note that to support the GCN wouldn't be much over the top of this scheme; we'd always infer the “global” namespace to be the same namespace the current actor is in, and anything in another SP would require full specification, i.e.: france:orange:pierre.

name: mcavage
- rule:

subject:

user: kabam:mark

action: map
resource:

user: mcavage

-rule

subject:

user: mcavage

action: login
resource:

smartmachine/node: 123

### Public API Changes Scoping

Endpoints for an individual have an implicit ownership to the person authenticating against the system:
Endpoints for and organization will be scoped by the unique name of the organization and will have to be explicitly declared in the URL:

### Steps to Completion

/vl/account
/vl/paymentmethods
/vl/smartmachines/node

/vl/kabam/account
/vl/kabam/paymentmethods
/vl/kabam/smartmachines/node

The work involved can be broken down into three different steps that have value at the completion of each step.

### Step 1—SSH Authentication

SSH Authentication against CAPI rather than authorized_keys.

### Step 2—Resource Permissions

Simply put, this allows a Customer to grant another Customer access to a subset of their resources.

### Step 3—Organizations and API Permissions

Create the concept of an Organization that allows Customers to belong to Organizations and control the API on behalf of the Organization. This Step has high value to few (but very large) Customers.
Default’ APIs; that is I can pass a flag at startComputeNode time that says “allow all my users to login”. Which would basically write a rule that says “myacct:* login 123”. Alternatively we could provide “default” roles that set up login, admin, etc. This is similar to what active directory et al do.

In the foregoing specification, the disclosure has been described with reference to specific example embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method for sizing resources in a cloud-based environment, the method comprising:
receiving quality of service requirements and a functional description of a cloud architecture associated with a cloud application, the cloud architecture including application resources and relations between the application resources;
performing latency analysis of data packets in a compute layer of the cloud architecture, the latency analysis including comparing size per time metrics of the data packets;
based on the latency analysis and the quality of service requirements, determining a minimal cloud architecture for the application, the minimal cloud architecture including the application resources to guarantee the quality of service requirements; and
providing to a data center the minimal cloud architecture.

2. The method of claim 1, wherein the application is running on a tablet-type client device.

3. The method of claim 1, wherein the functional description includes tiers of the cloud architecture.

4. The method of claim 1, wherein the cloud architecture includes one or more of the following: a load balancer, a firewall, a web server, an application server, a database, and a runtime environment.

5. The method of claim 1, further comprising guaranteeing content delivery within a content delivery network.

6. The method of claim 1, wherein latency is determined empirically by observing a workload of the application while the application is running on a user device.

7. The method of claim 1, wherein the minimal cloud architecture is provided to the data center via an Application Programming Interface (API) written in at least one of an Extensible Markup Language (XML) file and a JavaScript Object Notation (JSON) file.

8. The method of claim 1, wherein the quality of service requirements include one or more of the following: availability, performance, and a minimal uplink guarantee.

9. The method of claim 1, wherein the latency analysis is performed within a virtual environment and is based on kernel statistics, the kernel statistics including one or more of the following: a number of active processes, a total virtual memory size, and a number of hard disks used.

10. A method comprising:
executing instructions stored in memory, the instructions to be executed by a processor to:
receive quality of service requirements associated with an application; based on the quality of service requirements,
determine a cloud architecture for the application to guarantee quality of service;
perform latency analysis on data packets in communications between the application and an optimal application resources;
based on the latency analysis, determine sizes of resources included in the cloud architecture; and
provide resources and the sizes of resources to the data center.

11. A system for sizing resources in a cloud-based environment, the system comprising:
a memory for storing executable instructions for sizing the resources;
a processor configured to execute the instructions stored in the memory to:
receive quality of service requirements and a functional description of a cloud architecture associated with a cloud application, the cloud architecture including application resources and relations between the application resources;
perform latency analysis of data packets in a compute layer of the cloud architecture, the latency analysis including comparing size per time metrics of the data packets;
determine a minimal cloud architecture for the application based on the latency analysis and the quality of service requirements, the minimal cloud architecture including the application resources to guarantee the quality of service requirements; and
provide to a data center the minimal cloud architecture.

12. The system of claim 11, wherein the application is running on a tablet-type client device.

13. The system of claim 11, wherein the functional description includes tiers of the cloud architecture.

14. The system of claim 11, wherein the cloud architecture includes one or more of the following: a load balancer, a firewall, a web server, an application server, a database, and a runtime environment.

15. The system of claim 11, further comprising guaranteeing content delivery within a content delivery network.

16. The system of claim 11, wherein latency is determined empirically by observing a workload of the application while the application is running on a user device.

17. The system of claim 11, wherein the quality of service requirements include one or more of the following: availability, performance, and a minimal uplink guarantee.

18. The system of claim 11, wherein the latency analysis is performed within a virtual environment and is based on kernel statistics, the kernel statistics including one or more of the following: a number of active processes, a total virtual memory size, and a number of hard disks used.

19. A system comprising:
a memory for storing executable instructions for sizing the resources;
a processor configured to execute the instructions stored in the memory to:
receive quality of service requirements associated with an application;
determine a cloud architecture for the application to guarantee the quality of service based on the service requirements;
perform latency analysis on data packets in communications between the application and an optimal application resources;
determine sizes of resources included in the cloud architecture based on the latency analysis based on the latency analysis; and
provide the resources and the sizes to a data center.

20. A non-transitory computer readable storage medium having a program embodied thereon, the program executable by a processor in a computing device to perform a method for sizing resources in a cloud-based environment, the method comprising:
receiving quality of service requirements and a functional description of a cloud architecture associated with a cloud application, the cloud architecture including application resources and relations between the application resources;
performing latency analysis of data packets in a compute layer of the cloud architecture, the latency analysis including comparing size per time metrics of the data packets;
based on the latency analysis and the quality of service requirements, determining a minimal cloud architecture for the application, the minimal cloud architecture including the application resources to guarantee the quality of service requirements; and
providing to a data center the minimal cloud architecture.
